(19) United States
(12) Patent Application Publication
(10) Pub. No.: US 2005/0110777 A1
(43) Pub. Date: May 26, 2005

(54) Light-emitting stylus and user input device using same

(76) Inventors: Bernard O. Geaghan, Salem, NH (US); Michael J. Robrecht, Shorewood, WI (US)

Correspondence Address: 3M INNOVATIVE PROPERTIES COMPANY, PO BOX 33427, ST. PAUL, MN, 55133-3427, US

(21) Appl. No.: 10/721,603

(22) Filed: Nov. 25, 2003

(51) Int. Cl. G09G 5/00

(52) U.S. Cl. 345/179

(57) ABSTRACT

The present invention provides a light-emitting stylus configured to abruptly change a property of an emitted light beam when the stylus sufficiently contacts a surface. The abrupt change in the light beam is detectable by an array of light sensitive detectors that can be used to determine the position of the light beam when the light beam is transmitted through an input surface. When the stylus contacts the input surface, the detectors can detect the abrupt change in the emitted light, signaling a change from a stylus hover mode to a stylus touch down mode.

This invention relates to a light-emitting stylus and the use of a light-emitting stylus in a user input device.

### BACKGROUND

Touch sensors have become an increasingly common way for users to intuitively interact with electronic systems, typically those that include displays for viewing information. In many applications, the information is viewed through the touch-sensitive area so that the user seems to interact directly with the displayed information. Depending on the technology of the input device, a user may interact with the device using a finger or some other touch implement such as a stylus. When a stylus is used, it can be a passive object (as is typical for those used with resistive touch screens, for example in a personal digital assistant or other hand-held device) or an active object (as is typical for those used with signature capture devices). An active stylus can communicate signals with the input device, whether sending, receiving, or both, to determine touch position or other information. Active styli include those that send or receive radio frequency signals (RF pens), those that use magnetic fields for inductive signal capture (inductive pens), and those that emit or receive light (light pens).

### SUMMARY OF THE INVENTION

The present invention provides a stylus for use with a light sensitive user input device. The stylus includes a light-emitting device configured to emit a light beam through a tip of the stylus when the tip is not in contact with an input surface of the input device, the light beam having a property that abruptly changes when the tip of the stylus sufficiently contacts the input surface, the abrupt change in the light beam being detectable by the light sensitive user input device.

The present invention also provides an input device that includes a plurality of light sensors disposed to detect light transmitted through an input surface of the input device, a stylus configured to emit a light beam through a tip independent of whether the tip is in contact with the input surface, the light beam being detectable by the sensors, and electronics coupled to the sensors and configured to determine the light beam location at a reference plane. When the tip contacts the input surface, a property of the light beam abruptly changes in a manner detectable by the sensors. The present invention also provides a system that includes an electronic display disposed to display information viewable through the input surface of such an input device.

The present invention further provides a method for using an input device that includes a light-emitting stylus for emitting a light beam and a plurality of light sensors disposed to detect the light beam transmitted through an input surface of the input device. The method includes detecting the light beam when the stylus is not contacting the input surface, detecting the light beam when the stylus is contacting the input surface, abruptly changing a property of the light beam when the stylus sufficiently contacts the input surface, and detecting the abruptly changed property of the light beam.

The above summary of the present invention is not intended to describe each disclosed embodiment or every implementation of the present invention. The Figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1(a) and (b) schematically show the use of a light-emitting stylus according to the present invention;

FIG. 2(a) schematically shows one embodiment of a switch mechanism for changing a property of light emitted by a light-emitting stylus;

FIG. 2(b) schematically shows another embodiment of a switch mechanism for changing a property of light emitted by a light-emitting stylus;

FIG. 2(c) schematically shows another embodiment of a switch mechanism for changing a property of light emitted by a light-emitting stylus;

FIG. 3 schematically shows a light-emitting stylus that includes an auxiliary switch; and

FIG. 4 schematically shows one way of using of a light-emitting stylus in a user input device according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention relates to a light-emitting stylus and its use with an optical position digitizer, for example as a user input device. According to the present invention, characteristics of the emitted light beam can be changed based on whether or not the tip of the stylus is contacting the input surface. In use, the stylus can emit a beam of light detectable by an array of sensors. The sensors can be used to determine the position of the beam of light at a reference plane, for example the position of the light beam at the input surface. When the stylus is not contacting the input surface, the light beam exhibits certain detectable characteristics. When the stylus is contacting the input surface, one or more properties of the light beam are abruptly changed in a manner that can be detected by the sensors. As such, in addition to the position of the light beam, the user input system can determine the state of the stylus as it either hovers above the input surface or is in contact with the input surface.

The hover or contact information can be used to signify different modes of operation, to select different functions, and so forth. For example, when in hover mode (stylus not contacting the input surface), the emitted light beam can be used to move a cursor, highlight icons, tick through menu items, and so forth. When a user wishes the system to perform a function associated with the item highlighted during hover mode, the stylus can be brought into contact with the input surface at the position of the highlighted item. As another example, contact mode can be used for signature capture or another specific function to simulate using an ink pen on paper. In some embodiments, a switch can be provided on the stylus so that a property of the light beam can be changed in a manner detectable by the array of light sensors independent of whether the input surface is contacted with the stylus. This auxiliary switch can be used to select the same or a different operative function as that selected by contact of the stylus with the input surface. The auxiliary switch can control a beam on/off function, signify a left or right mouse button click action, and so forth. In many embodiments, it may be desirable to couple the light-emitting stylus and input device with an electronic display that is viewable through the input surface.

FIG. 1(a) shows a light-emitting stylus 110 configured to emit a light beam B through a tip 112. The light beam B can be directed toward an input surface 122. The light beam can be detected by an array of light sensors (not shown) that are associated with the input surface 122. For example, the light sensors can be disposed to sense light transmitted through the input surface 122. If input surface 122 is a surface of a layer 120, the light sensors can be embedded within layer 120, the light sensors can be disposed on the opposing surface 124 of layer 120, or the light sensors can be provided in any other manner so that input surface 122 is interposed between the stylus 110 and the sensors. For example, the light sensors can be formed as part of an electronic display, and layer 120 can be a layer of that display, or a layer disposed over (whether in contact with or apart from) that display. When the stylus 110 is emitting light through input surface 122 and is not contacting the input surface, the stylus can be said to be in “hover” mode.

FIG. 1(b) shows the same light-emitting stylus 110 where the tip 112 of the stylus is contacting the input surface 122. When the tip 112 of the stylus contacts the input surface 122 (or any other surface), a property of the emitted light beam is abruptly changed, the changed light beam denoted B′. The abrupt change in the light beam can be actuated using a switch mechanism coupled to the tip and activated by sufficient contact of the tip with a surface. Light beam B′ can be transmitted through input surface 122 to be detected by the array of light sensors (not shown) in the same manner as light beam B of FIG. 1(a). When the stylus 110 is emitting light through input surface 122 and is contacting the input surface, the stylus can be said to be in “inking” mode.

The change to the light beam exhibited when tip 112 contacts input surface 122 is a distinct, abrupt change that is detectable by the light sensors to distinguish between hover mode and inking mode. An abrupt change is distinguished from a smooth, continuous, and incremental change, such as the difference in beam width in the plane of the detectors when a non-collimated beam source is moved from just above an input surface to contacting the input surface. Properties of the emitted light beam that can be changed when the tip contacts a surface include, for example, the light beam intensity (e.g., higher intensity, lower intensity, different cross-sectional intensity profile, and the like), the light beam wavelength (e.g., from one color to another, from a narrower to a wider range of wavelengths, and so forth), the spread of the light beam (e.g., from a collimated beam to a spread-out beam, an abrupt change in spot size, and so forth), the modulation of the light beam (e.g., a change in the frequency modulation of the beam, a change in duty cycle or pulse width of a modulated beam, and so forth), the polarization or orientation of the light beam, and the like. The light sensors can directly detect the abrupt change (for example, changes in intensity, duty cycle, beam width, etc.), or can detect the abrupt change indirectly through a detectable effect of the abrupt change (for example, in systems that use a polarizer or color filter between the light beam and the detectors, an abrupt change in polarization or color of the beam can result in a detectable change in beam intensity).

Any number of mechanisms can be used to produce the detectable, abrupt change in the light beam upon contact of the stylus with a surface. The type of mechanism can depend on the change being produced. For example, when the change can be produced through electronics, it may be desirable to connect an electrical switch to the tip of the stylus so that contacting the tip of the stylus to a surface switches the device from one emitting state to another emitting state. As another example, when the change can be produced through optics, it may be desirable to configure a lens or an aperture in the tip of the stylus so that contacting the tip of the stylus to a surface changes the distance between the light source and the lens or aperture, thereby changing the spread of the beam in a detectable manner. As another example, the mechanism may be a mechanical switch that changes an aperture size, changes a color or polarization filter condition, or the like.

A light-emitting stylus useful in the present invention can take any suitable form, and desirably is capable of being easily held and maneuvered by a human hand. A light-emitting stylus generally includes a housing that contains a light-emitting device, such as a light-emitting diode (LED), disposed to emit light through an aperture, a lens, a light pipe, an optical fiber, or the like, that defines a tip of the stylus. In the present invention, the tip is coupled to a switch or some other mechanism that is used to signal or control abruptly changing a property of the emitted light beam in a manner detectable by an array of light sensors when the stylus contacts an input surface, to distinguish between hover and inking modes. Light-emitting styli of the present invention can also incorporate switches accessible to a user for manually controlling the light beam, for example to turn the light beam on and off, to change a property of the light beam without activating the tip switch, and the like. Examples of light pens having some components that may be suitably implemented in light-emitting styli of the present invention are disclosed in the following publications: U.S. 2003/0122749; WO 03/058588; WO 03/071345; U.S. Pat. No. 6,600,478; U.S. Pat. No. 6,337,918; U.S. Pat. No. 6,377,249; U.S. Pat. No. 6,404,416; U.S. Pat. No. 5,600,348; U.S. Pat. No. 5,838,308; JP 10-187348; JP 10-283113; JP 58-086674; JP 60-198630; JP 60-200388; JP 61-006729; JP 61-075423; JP 61-122738; JP 62-092021; and JP 7-028584, each of which is wholly incorporated into this document as if reproduced in full.

Light beams emitted by styli of the present invention can be detected by an array of light sensitive detectors configured to sense light transmitted through an input surface. By knowing which of the detectors are sensing the emitted light, the position of the light beam at the input surface, or other reference plane, can be determined. The light-emitting stylus and array of detectors can thus be used as a user input device by associating various functions of an electronic system or display with the positional information. An exemplary array of light sensitive detectors is an array of photo diodes, such as those disclosed in the following publications: WO 03/071345; U.S. Pat. No. 6,337,918; U.S. Pat. No. 5,838,308; JP 10-187348; JP 10-283113; JP 58-086674; JP 60-198630; JP 60-200388; JP 61-006729; JP 61-075423; JP 11-282628; and JP 2003-66417, each of which is wholly incorporated into this document as if reproduced in full. Other suitable arrays of light detectors include the light-emitting devices of organic electroluminescent displays (OLEDs) as disclosed in International Publication WO 03/058588, which is hereby incorporated by reference. In addition to emitting light, OLED devices can also detect light. As disclosed in WO 03/058588, by properly modulating the emitting and detecting functions of OLED devices, display pixels can perform a dual function seemingly simultaneously. As such, it may be possible to fit existing OLED displays with new electronics to convert the existing displays into dual function displays and input devices. The pixel transistors already provided in active matrix liquid crystal displays (AMLCDs) can also be used to detect light. For example, a light-emitting stylus can be configured to emit a wavelength of light that is likely to produce a photo-induced current in the pixel transistors of an AMLCD, preferably with the emitted light modulated so that the light emitted by the stylus can be distinguished from ambient light. The present invention contemplates these and any other suitable light detector arrays. Light detector arrays can be provided as a separate device coupled to the user input system, as a separate layer in a user input system, or as an integral part of a display device. When the light detectors are integrated into a display device such as an LCD, it may be desirable to locate such detectors within areas covered by the black matrix, for example so that there is little or no reduction in pixel area. In such a case, it may be desirable to form apertures in the black matrix aligned with the light detectors to allow light to reach the light detectors. This can be done during patterning of the black matrix.

In embodiments where the display incorporates color filters, the color filters can be advantageously used in concert with an array of light detectors. For example, if the light detectors were disposed to receive light transmitted through the blue color filters of an LCD, a light emitting stylus could be used that emits light only (or primarily) in a wavelength range transmitted by the blue color filter. Since ambient light contains a relatively low intensity level of blue light, detecting only the blue light emitted by the stylus can increase the signal to noise ratio due to a reduction in the noise. In other applications, color filters can be used to distinguish between hover and inking modes. For example, one array of light detectors can be disposed to sense light transmitted by one set of color filters (for example, blue), and another array of light detectors can be disposed to sense light transmitted by another set of color filters (for example, red). When the stylus is not contacting the input surface, the stylus can emit blue light, which is detected only by the detectors positioned behind the blue color filters. When the stylus contacts the input surface, red light can be emitted that is detected only by the detectors positioned behind the red color filters. Other combinations can also be used. Analogous arrangements employing other filters can also be used for such purposes, for example using polarization filters, rather than color filters, to increase signal to noise ratios or to distinguish among stylus modes. It should also be noted that OLED devices can be used to discriminate among wavelengths, much like color filters. OLED devices that emit a particular color of light are also more efficient at absorbing corresponding wavelengths. As such, when OLED devices are used as the detector array, they can be used to increase signal to noise ratios or to distinguish colors emitted by one or more styli.

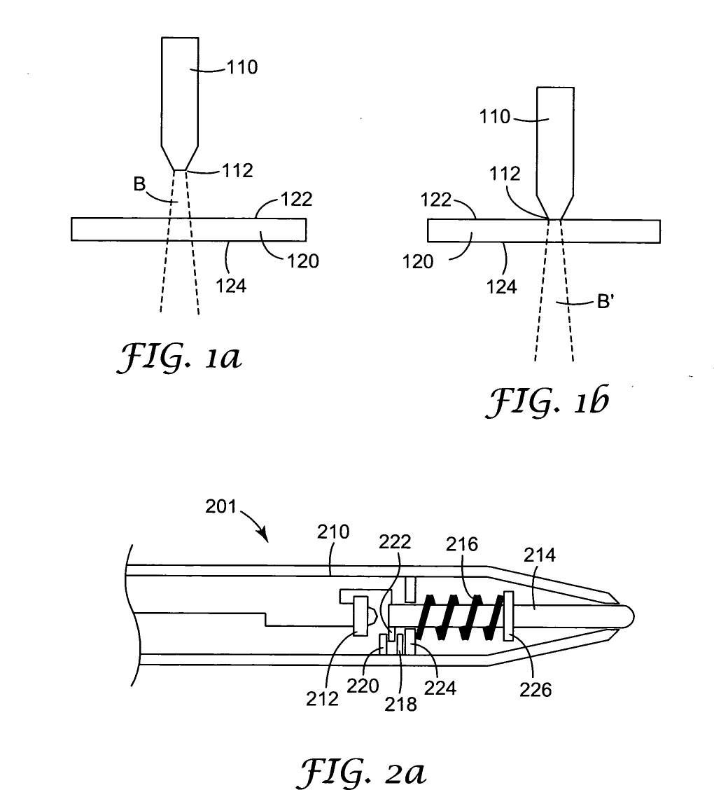

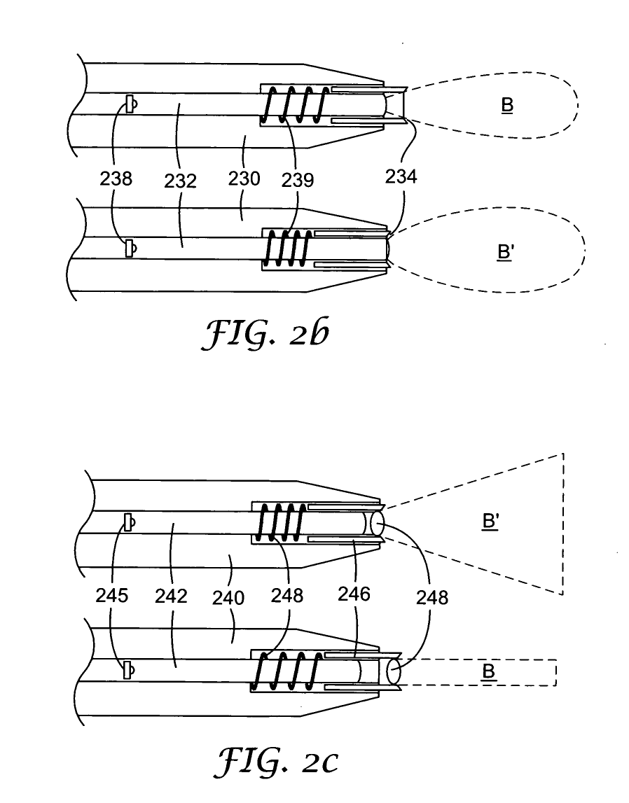

FIGS. 2(a)-(c) schematically show some non-limiting examples of mechanisms for abruptly changing a property of a light beam emitted by a stylus according to the present invention. FIG. 2(a) shows a portion of a light-emitting stylus 201 that includes a housing 210 provided in the shape of a pen, although any suitable stylus shape can be used. Housing 210 encloses a light-emitting device 212 that is configured to emit light through a light guide 214. Light guide 214 protrudes through an opening of the housing, the protruding portion of the light guide acting as a tip of the light-emitting stylus. Light emitted from the tip emerges as a beam of light. Housing 210 also encloses a switch assembly that includes a spring mechanism and a switch mechanism. The spring mechanism includes a spring 216 wrapped around light guide 214. Spring 216 pushes against a first, stationary, spring stop 224 that is attached to the interior of the housing 210, and a second spring stop 226 that is attached to the light guide. When the tip is not in contact with a surface, an electrode 222 attached to the light guide engages a first switch electrode 218, the action of the spring 216 maintaining the contact. This completes a first circuit that causes light-emitting device 212 to emit light having a certain set of characteristics. When the tip is in contact with a surface, the tip is pushed back into the housing so that electrode 222 engages a second switch electrode 220. This completes a second circuit that causes light-emitting device 212 to emit light having a different set of characteristics that are distinguishable by the light detector array. For example, the circuit including switch electrode 218 may include a different resistor than the circuit including switch electrode 220, thereby changing the intensity of the light beam. The switch mechanism may also affect the modulation of the light beam, the color of the light beam, and so forth. As another example, more than one light-emitting device can be used, with the tip switch controlling which device or devices is or are activated.

FIG. 2(b) shows two views of a light-emitting stylus 230, the upper view indicating a tip position when the stylus is not in contact with a surface, and the lower view indicating a tip position when the stylus is contacting a surface. Stylus 230 includes a light-emitting device 238 configured to emit light through a light guide 232. An aperture 234 forms the tip of the stylus, and controls the spread of the light beam emitted from the end of the light guide based on the distance between the exit of the aperture and the end of the light guide. As shown, when the tip is not in contact with a surface, the exit of the aperture is farther away from the end of the light guide, resulting in a narrower beam spread B. When the tip is in contact with a surface, the exit of the aperture is closer to the end of the light guide, resulting in a broader beam spread B′. A spring 239 can be used to maintain the hover mode aperture position when pressure is not applied to the tip, and to allow the aperture to move inward, closer to the light source, upon contact with a surface.

FIG. 2(c) shows two views of the same light-emitting stylus 240, the lower view indicating a tip position when the stylus is not in contact with a surface, and the upper view indicating a tip position when the stylus is contacting a surface. Stylus 240 includes a light-emitting device 245 configured to emit light through a light guide 242. A cylinder 246 is disposed near the tip of the light guide, the cylinder containing a lens 248 disposed to emit the light beam B. Cylinder 246 forms a tip that is movable in and out of the stylus with the help of urging from spring 248. In the configuration shown, the cylinder 246 is fully extended when the tip is not in contact with a surface, resulting in a lens position that creates a relatively focused, collimated beam of light B. When the tip is in contact with a surface, the cylinder 246 is pushed in, causing the lens 248 to spread the light beam as shown by beam B′.

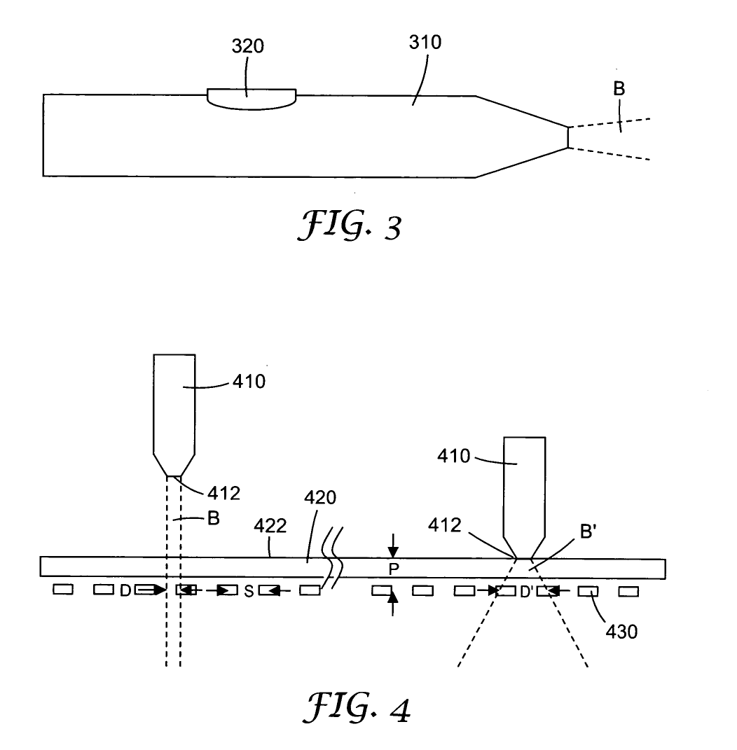

FIG. 3 shows a light-emitting stylus 310 that includes a side, or auxiliary, switch 320 for activating or changing properties of an emitted light beam B regardless of whether a tip switch (not indicated) is activated. The side switch can be a pressure activated switch that makes or breaks an electrical contact, resulting in a signal. The signal may be a change in the stylus beam such as a change in beam intensity, duty cycle of a modulated beam, frequency of modulation of the beam, color of the beam, polarization of light in the beam, the on/off condition of the beam, and so forth. The change in stylus beam may be detected by the light sensors of a user input device and may be interpreted as the equivalent of a right or left mouse click, or a change in status of the stylus. The side switch 320 may be a capacitive sensing transducer that activates when touch contact is made to a specified area of the stylus housing.

FIG. 4 depicts one method of utilizing a light-emitting stylus of the present invention in a user input device. Stylus 410 is configured to emit a beam of light B through a tip 412 when the tip is not in contact with a surface, and to emit a beam of light B′ through the tip 412 when the tip is in contact with a surface. Light beam B is relatively collimated whereas light beam B′ has a conical shape that spreads with distance from the tip of the stylus 410. FIG. 4 also shows a layer 420 that is transmissive to light beams B and B′, layer 420 exhibiting an input surface 422. An array of light detectors 430 is associated with the device, the light detectors being disposed to sense light transmitted through substrate 420. Light detectors 430 are spaced a distance S apart, center-to-center, and are set a distance P below the input surface 422. Light beam B has a beam spot diameter D at the plane of the detectors 430. To increase the likelihood that beam B will be detected at all locations, spot diameter D is desirably on the order of detector spacing S. In this case, the positional resolution of beam location determination is equal to 1/S. Light beam B′ spreads out with distance from the tip of the stylus 410 and has a beam diameter D′ at the plane of the light detectors, D′ being greater than the spacing S of the detectors. If D′ is large enough so that at least two detectors will be illuminated by light beam B′ at all locations of interest, the position of the light beam may be determined to a resolution greater than 1/S by using interpolation techniques. As such, the present invention can be used to locate a light beam from a stylus used in hover mode, and to locate the light beam with even greater resolution when the stylus contacts the input surface. In some applications, lower positional resolution may be adequate or even desirable when the stylus is in hover mode. This can also allow for the use of a more collimated, laser-like beam that can be detected from a large distance, for example as with a laser pointer. The same system can then be used for higher resolution position detection when the stylus is contacting the input surface.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. A stylus for use with a light sensitive user input device, comprising:
a light-emitting device configured to emit a light beam through a tip of the stylus when the tip is not in contact with an input surface of the input device, the light beam having a property that abruptly changes when the tip of the stylus sufficiently contacts the input surface, the abrupt change in the light beam being detectable by the light sensitive user input device.

2. The stylus of claim 1, further comprising a switch coupled to the tip, the switch configured to actuate the abrupt change.

3. The stylus of claim 1, wherein the abrupt change is a change in beam intensity.

4. The stylus of claim 1, wherein the abrupt change is a change in beam wavelength.

5. The stylus of claim 1, wherein the abrupt change is a change in beam modulation.

6. The stylus of claim 5, wherein the change in beam modulation is a change in frequency modulation.

7. The stylus of claim 5, wherein the change in beam modulation is a change in duty cycle of the modulation.

8. The stylus of claim 5, wherein the change in beam modulation is a change in pulse width of the modulation.

9. The stylus of claim 1, wherein the abrupt change is cross-sectional size of the beam.

10. The stylus of claim 1, wherein the abrupt change is a change in polarization.

11. The stylus of claim 1, further comprising an auxiliary switch for controlling the light beam.

12. The stylus of claim 11, wherein the auxiliary switch turns the light beam on and off.

13. The stylus of claim 11, wherein the auxiliary switch causes the abrupt change in the light beam to simulate a condition where the tip contacts the input surface.

14. The stylus of claim 11, wherein the auxiliary switch changes the beam intensity.

15. The stylus of claim 11, wherein the auxiliary switch changes the beam modulation.

16. The stylus of claim 11, wherein the auxiliary switch changes the beam wavelength.

17. The stylus of claim 11, wherein the auxiliary switch focuses the beam.

18. The stylus of claim 11, wherein the auxiliary switch defocuses the beam.

19. A user input device comprising:
a plurality of light sensors disposed to detect light transmitted through an input surface of the input device;
a stylus configured to emit a light beam through a tip independent of whether the tip is in contact with the input surface, the light beam being detectable by the sensors; and
electronics coupled to the sensors and configured to determine the light beam location at a reference plane,
wherein when the tip contacts the input surface, a property of the light beam abruptly changes in a manner detectable by the sensors.

20. The user input device of claim 19, wherein the input surface comprises an exterior surface of an electronic display.

21. The user input device of claim 20, wherein the electronic display comprises a liquid crystal display.

22. The user input device of claim 20, wherein the electronic display comprises an organic electroluminescent display.

23. The user input device of claim 20, wherein the plurality of light sensors are integrated into a transistor array that controls pixels of the electronic display.

24. The user input device of claim 19, wherein the reference plane is the input surface.

25. The user input device of claim 19, wherein the light sensors are configured to detect light within a selected range of wavelengths, and the light beam exhibits a color within the selected range of wavelengths.

26. The user input device of claim 25, further comprising color filters disposed to filter light received by the light sensors.

27. The user input device of claim 26, wherein the color filters are blue color filters, and the stylus is configured to emit blue light.

28. A system comprising a user input device according to claim 19 and an electronic display disposed to display information through the input surface of the input device.

29. The system of claim 28, wherein the electronic display is a liquid crystal display.

30. The system of claim 29, wherein the plurality of light sensors is incorporated into the liquid crystal display.

31. The system of claim 28, wherein the electronic display comprises a plurality of organic electroluminescent light-emitting devices.

32. The system of claim 31, wherein at least a portion of the organic electroluminescent light-emitting devices are used as the light sensors.

33. A method for using an input device that includes a light-emitting stylus for emitting a light beam and a plurality of light sensors disposed to detect the light beam transmitted through an input surface of the input device, the method comprising:
detecting the light beam when the stylus is not contacting the input surface;
detecting the light beam when the stylus is contacting the input surface;
abruptly changing a property of the light beam when the stylus sufficiently contacts the input surface; and
detecting the abruptly changed property of the light beam.

34. The method of claim 33, further comprising determining the location of the light beam at a reference plane when the stylus is not contacting the input surface.

35. The method of claim 33, further comprising determining the location of the light beam at a reference plane when the stylus is contacting the input surface.
